(19) United States
(12) Patent Application Publication
(10) Pub. No.: US 2003/0082317 A1
(43) Pub. Date: May 1, 2003

(54) Decorative grass formed of cloth and cloth laminated to paper

(76) Inventor: Donald E. Weder, Highland, IL (US)

Correspondence Address: DUNLAP, CODDING & ROGERS P.C., PO BOX 16370, OKLAHOMA CITY, OK, 73114, US

(21) Appl. No.: 10/316,744

(22) Filed: Dec. 10, 2002

Related U.S. Application Data
(63) Continuation of application No. 09/696,270, filed on Oct. 25, 2000, now abandoned.
Application No. 09/696,270 is a continuation-in-part of application No. 09/040,940, filed on Mar. 18, 1998, now Pat. No. 6,258,447.
(63) Continuation-in-part of application No. 10/127,137, filed on Apr. 10, 2002.
Application No. 10/127,137 is a continuation of application No. 09/484,677, filed on Jan. 18, 2000, now Pat. No. 6,394,276.
Application No. 09/484,677 is a continuation of application No. 09/188,876, filed on Nov. 9, 1998, now Pat. No. 6,041,936.
Application No. 09/188,876 is a continuation of application No. 08/892,675, filed on Jul. 14, 1997, now Pat. No. 5,906,280.

(51) Int. Cl. A01N 3/00

(52) U.S. Cl. 428/17

(57) ABSTRACT

Wrappers and sleeves for flower pots and floral groupings, ribbon material and decorative grasses formed from a material constructed of a layer of cloth alone or in combination with a sheet of paper, as well as methods for forming same, are disclosed herein. The material constructed of a layer of cloth alone or in combination with a sheet of paper may have a substantially undistorted pattern printed thereon.

### FIELD OF THE INVENTION

The present invention relates to methods for forming wrappers for flower pots and floral groupings and producing ribbon material and decorative grasses, and more particularly but not by way of limitation, to methods for forming wrappers for flower pots and floral groupings and producing ribbon material and decorative grasses from a sheet of material constructed from natural or synthetic fibers or combinations thereof alone or in combination with a sheet of paper.

### BRIEF DESCRIPTION OF THE DRAWINGS

FIG. 1 is a perspective view of a sheet of material constructed in accordance with the present invention, the sheet of material having one corner thereof turned upwardly.

FIG. 1A is a perspective view of a sheet of material constructed in accordance with the present invention and having a substantially undistorted pattern printed thereon, one corner of the sheet of material being turned upwardly.

FIG. 1B is a schematic representation of a method for producing sheets of material constructed in accordance with the present invention, the sheets of material having different substantially undistorted printed patterns thereon.

FIG. 2 is a perspective view of a sheet of laminated material constructed in accordance with the present invention, one corner of the sheet of laminated material being turned upwardly.

FIG. 3 is a perspective view of a sheet of laminated material similar to the sheet of laminated material of FIG. 2, the sheet of laminated material having a bonding material disposed along one edge thereof, one corner of the sheet of laminated material being turned upwardly.

FIG. 4 is a perspective view of the sheet of material of FIG. 3 having a floral grouping disposed thereon.

FIG. 5 is a perspective view of the floral grouping of FIG. 4 being wrapped with the sheet of material of FIG. 3 by one method of wrapping.

FIG. 6 is a perspective view of a decorative cover for the floral grouping formed from the sheet of material of FIG. 3.

FIG. 7 is a perspective view of another embodiment of a decorative cover for the floral grouping formed from the sheet of material of FIG. 3.

FIG. 8 is a perspective view of a decorative cover positioned about a flower pot wherein the decorative cover is formed from the sheet of material of FIG. 2.

FIG. 9 is a cross-sectional view of a flower pot cover former and band applicator device having the sheet of material of FIG. 2 disposed above an opening in the flower pot cover former and band applicator device and having a flower pot disposed above the sheet of material.

FIG. 10 is a perspective view of a floral sleeve constructed in accordance with the present invention.

FIG. 11 is a perspective view of the floral sleeve of FIG. 10 disposed about a floral grouping.

FIG. 12 is a perspective view of a floral sleeve constructed in accordance with the present invention, the floral sleeve having a cinching member.

FIG. 13 is a perspective view of the floral sleeve of FIG. 12 disposed about a floral grouping.

FIG. 14 is an elevational view of a sleeve having a detachable portion constructed in accordance with the present invention.

FIG. 15 is a perspective view of the sleeve of FIG. 14 having a flower pot disposed therein.

FIG. 16 is a perspective view of the flower pot disposed in the sleeve of FIG. 15 wherein an upper portion of the sleeve has been removed to provide a decorative cover having a skirt.

FIG. 17 is a perspective view of a ribbon material formed from the sheet of material of FIG. 1.

FIG. 18 is a perspective view of a ribbon material formed from the sheet of material of FIG. 1A.

FIG. 19 is a perspective view of a ribbon material formed from the sheet of laminated material of FIG. 2.

FIG. 20 is a perspective view of a ribbon material formed from a sheet of laminated material and having a substantially undistorted printed pattern disposed thereon.

FIG. 21 is a schematic representation of a system for making decorative grass from a sheet of material constructed in accordance with the present invention.

FIG. 22 is a perspective view of a segment of decorative grass produced from the sheet of material of FIG. 1.

FIG. 23 is a perspective view of a segment of decorative grass produced from the sheet of material of FIG. 1A.

FIG. 24 is a perspective view of a segment of decorative grass produced from the sheet of laminated material of FIG. 2.

### DETAILED DESCRIPTION OF THE INVENTION

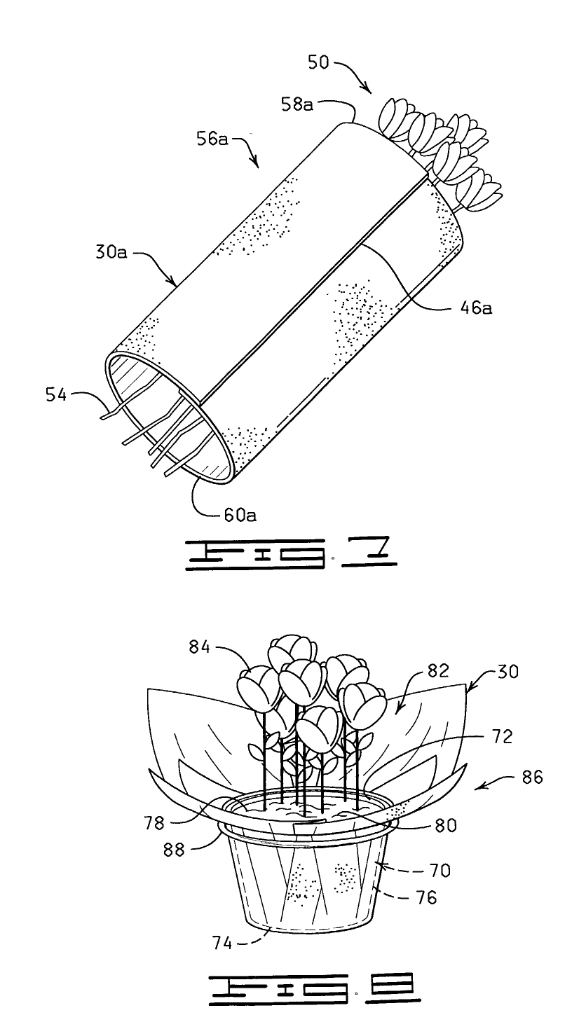

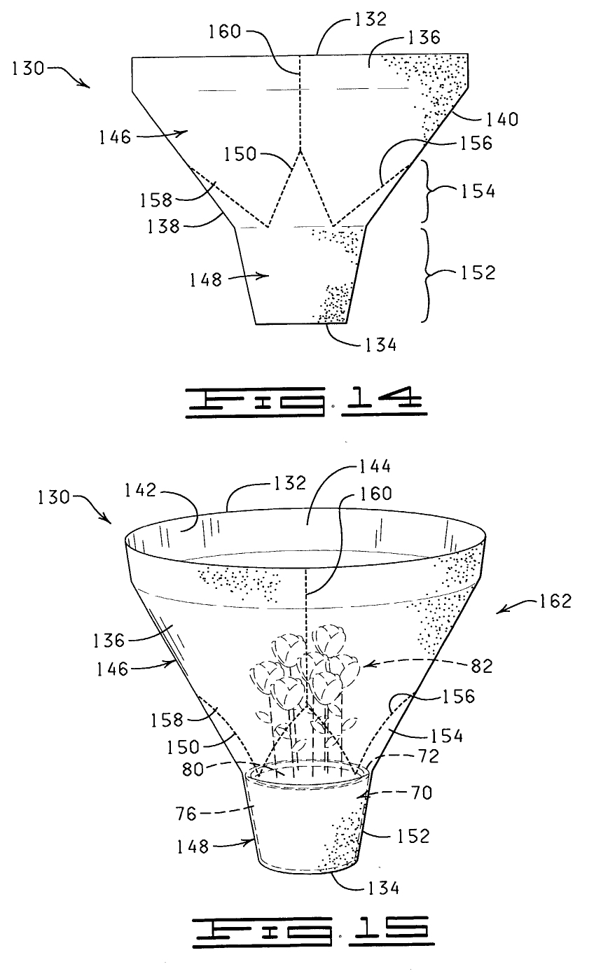

Sheets of material constructed in accordance with the present invention may be employed to provide a decorative cover for a floral grouping (FIGS. 4-7) or a decorative cover for a flower pot (FIG. 8); to provide a sleeve for wrapping or covering a floral grouping (FIGS. 10-13) or a flower pot (FIGS. 14-16); to provide a ribbon material (FIGS. 17-20) or to produce decorative grass (FIGS. 21-24). Such uses of the sheets of material of the present invention will be described in detail herein after with reference to FIGS. 4-24.

The term “flower pot” as used herein refers to any type of container for holding a floral grouping, a plant, or any another pot-type container. Examples of flower pots and/or pot-type containers include, but are not limited to, clay pots, wooden pots, plastic pots, pots made from natural and/or synthetic fibers, or any combination thereof. Such flower pots and/or pot-type containers are provided with a retaining space for receiving a floral grouping. The floral grouping may be disposed within the retaining space of the flower pot with a suitable growing medium, or other retaining medium, such as a floral foam. It will also be understood that in some cases the floral grouping, and any appropriate growing medium or other retaining medium, may be disposed in a sleeve formed from the sheet of material constructed in accordance with the present invention if the sleeve is adapted to contain a medium.

“Floral grouping” as used herein refers to cut fresh flowers, artificial flowers, a single flower or other fresh and/or artificial plants or other floral materials and may include other secondary plants and/or ornamentation or artificial or natural materials which add to the aesthetics of the overall floral grouping. Further, the floral grouping may comprise a growing potted plant having a root portion as well. However, it will be appreciated that the floral grouping may consist of only a single bloom or only foliage, a botanical item, or a propagule. The term “floral grouping” may be used interchangeably herein with the terms “floral arrangement”, “botanical item” and/or “propagule.”

The term “growing medium” when used herein refers to any liquid, solid or gaseous material used for plant growth or for the cultivation of propagules, including organic and inorganic materials such as soil, humus, perlite, vermiculite, sand, water, and including the nutrients, fertilizers or hormones or combinations thereof required by the plants or propagules for growth.

The term “botanical item” when used herein refers to a natural or artificial herbaceous or woody plant, taken singularly or in combination. The term “botanical item” also refers to any portion or portions of natural or artificial herbaceous or woody plants including stems, leaves, flowers, blossoms, buds, blooms, cones, or roots, taken singularly or in combination, or in groupings of such portions such as bouquets or floral groupings.

The term “propagule” when used herein refers to any structure capable of being propagated or acting as an agent of reproduction including seeds, shoots, stems, runners, tubers, plants, leaves, roots or spores.

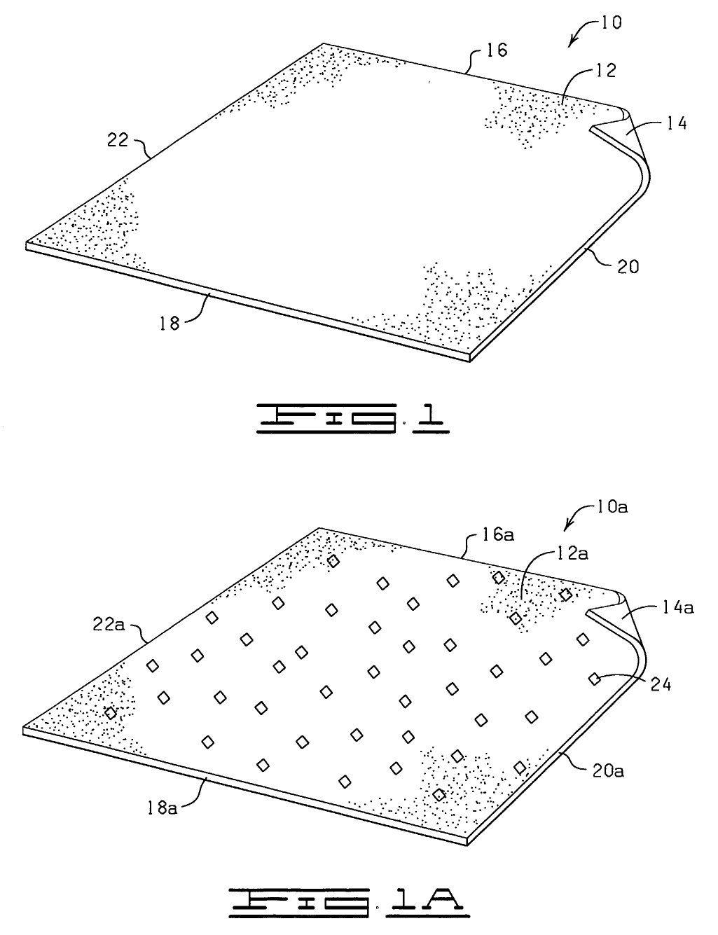

### Description of FIGS. 1-3

Referring now to the Drawings, and more particularly to FIG. 1, shown therein is a sheet of material 10 formed of cloth and constructed in accordance with the present invention. The sheet of material 10 has an upper surface 12, a lower surface 14, a first side 16, a second side 18, a third side 20 and a fourth side 22.

The term “cloth” as used herein will be understood to include any type of fabric material, including woven fabric, nonwoven fabric, welded fabric, spun bonded fabric, knitted fabric, pressed fabric, other types of fibrous material, and combinations thereof. Examples of cloth include fabrics formed from natural fibers such as cotton, wool, silk, hair, burlap, and linen, as well as synthetic fibers such as rayon and polyester, and blends thereof, such as denim.

The sheet of material 10 is illustrated as being square. It will be appreciated, however, that the sheet of material 10 can be of any shape, configuration or size as long as the sheet of material 10 is sufficiently sized and shaped to wrap and encompass a floral grouping or a flower pot. For example, the sheet of material 10 may have a rectangular, round, oval, octagonal or asymmetrical shape.

Any thickness or stiffness of the cloth of the sheet of material 10 may be utilized in accordance with the present invention as long as the sheet of material 10 can be wrapped about at least a portion of a floral grouping or a flower pot to form a decorative cover for the floral grouping or flower pot, or formed into a sleeve for wrapping or covering a floral grouping or a flower pot, or to provide ribbon or decorative grass. Generally, the sheet of material 10 will have a thickness in a range of from about 0.5 mil to about 30 mil, and desirably from about 0.6 mil to about 10 mil.

Multiple sheets of material 10 may be used in a single circumstance to provide a decorative cover or sleeve for a floral grouping or a flower pot. Moreover, when multiple sheets of material 10 are used in combination, the sheets of material 10 need not be uniform in size or shape.

The sheet of material 10 may vary in color, depending at least in part on the type of cloth utilized. The sheet of material 10 may have decorative patterns or designs which are provided on at least one surface thereof which may be provided by printing, embossing, matting, texturing, flocking, application of foamable lacquers or foamable inks, and variations thereof and combinations thereof.

Shown in FIG. 1A is a sheet of material 10a formed of cloth and similar to the sheet of material 10, except as described herein below. The sheet of material 10a has an upper surface 12a, a lower surface 14a, a first side 16a, a second side 18a, a third side 20a, and a fourth side 22a. In addition, the sheet of material 10a is further provided with a substantially undistorted printed pattern 24. The substantially undistorted printed pattern 24 may be any shape, design, or form, including any geometric form or combination of geometric forms, such as squares, round spots, triangles, rectangles, octagonals, or the like, or any non-geometric, asymmetrical or fanciful forms or any combination thereof, including hearts, balloons, flowers, lace, slogans, logos, print (any combination of letters and/or numbers), signs, human forms (real and fictional), animal forms (real and fictional), cartoon characters, works of art, musical scores and/or plant and floral forms. Such substantially undistorted printed pattern 24 may include a single color or a combination of colors.

As shown in FIG. 1B, the sheet of material 10a may be produced from a roll of cloth 26, and upon withdrawal of a portion of the roll of cloth 26, the printed pattern 24 is applied thereto by a printing element 27. Such a method of producing the sheet of material 10a is advantageous in that only one inventory or roll of cloth 26 is required, but more than one printed pattern 24 may be applied to the withdrawn portions of the roll of cloth 26 via the use of a plurality of alternating printing elements 27, resulting in more than one sheet of material 10a, wherein the different sheets of material 10a may have different printed patterns 24 disposed thereon. Therefore, multiple sheets of material 10a, each having a different and/or unique printed pattern 24 thereon, can be produced from a single roll of material 26.

The different types of cloth utilized as the roll of cloth 26 which subsequently form the sheets of material 10a have textured surfaces which may distort the inks applied thereto to provide the printed pattern 24, and therefore a need exists in the art for better methods of printing patterns on cloth which has a highly textured surface. The present invention contemplates the application of a finish 28 to at least one of the upper surface 12a and the lower surface 14a of the sheet of material 10a prior to application of the printed pattern 24, thereby “sealing” such surface of the sheet of material 10a and providing a substantially smooth surface on which to apply the printed pattern 24, thereby preventing distortion of the printed pattern 24. The finish 28 may be substantially clear, such as a lacquer or wax (or wax paper, as will be described herein after), or the finish 28 may be a background color applied to the roll of cloth 26 or the sheet of material 10a prior to the printed pattern 24. The finish 28 may be applied by any method known in the art.

Optionally, an ink produced for non-distorted application to cloth is also contemplated by the present invention. Such an ink includes an anti-bleeding agent (as will be described in detail herein below) combined with a pigment. Such an ink provides the printed pattern 24 which is not distorted.

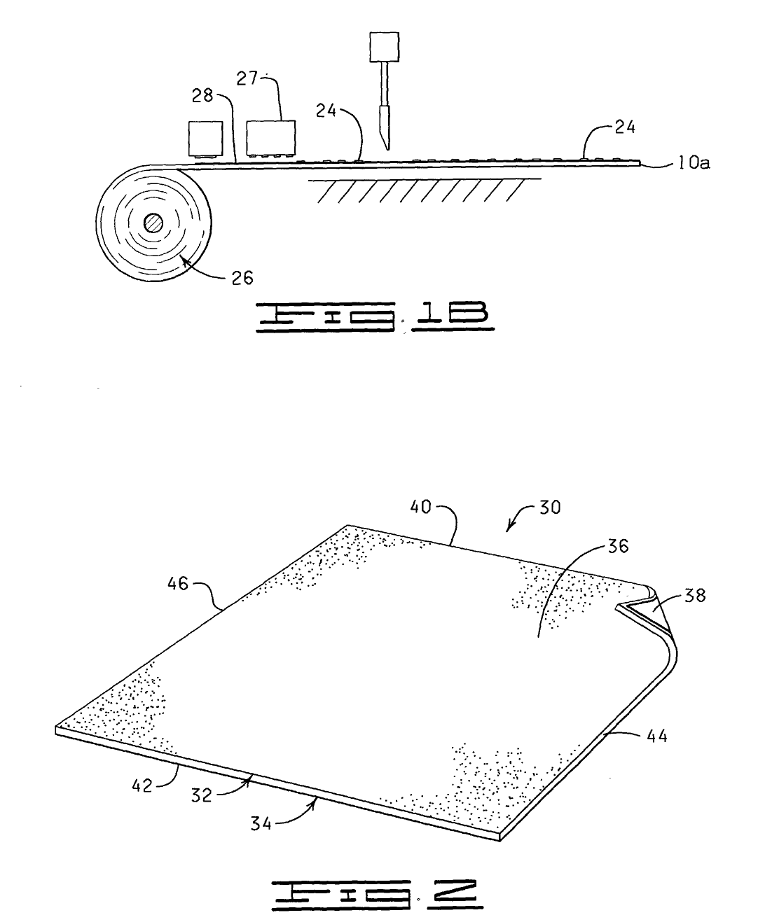

Shown in FIG. 2 is a sheet of laminated material 30 constructed in accordance with the present invention. The sheet of laminated material 30 comprises a layer of cloth 32 and a sheet of paper 34. The sheet of laminated material 30 has an upper surface 36, a lower surface 38, a first side 40, a second side 42, a third side 44 and a fourth side 46.

The term “paper” as used herein will be understood to refer to a thin, flexible material made from a pulp prepared from rags, wood or other fibrous material. Any form of paper may be utilized as the sheet of paper 34, including, but not limited to, waxed paper and paper towels. When waxed paper is utilized as the sheet of paper 34, the laminated material 30, and therefore a decorative cover formed therefrom, may be substantially water-impermeable.

At least a portion of the sheet of paper 34 may be laminated to the layer of cloth 32 to form the sheet of laminated material 30 by any method known in the art so that one surface of the laminated material 30, such as the upper surface 36, is cloth and the second surface of the laminated material 30, such as the lower surface 38, is paper. For example, U.S. Pat. No. 4,297,811 entitled “Laminated Printed Foil Flower Pot Wrap With Multicolor Appearance” issued to Weder on Nov. 3, 1981, which is hereby expressly incorporated herein by reference, describes a method for laminating two sheets of material using a bonding material. The sheet of paper 34 may be laminated to the layer of cloth 32 using a colored adhesive so as to impart a desired color to the sheet of laminated material 30.

The sheet of laminated material 30 is illustrated as being square. It will be appreciated, however, that the sheet of laminated material 30 can be of any shape, configuration or size as long as the sheet of laminated material 30 is sufficiently sized and shaped to wrap and encompass a floral grouping or flower pot. For example, the sheet of laminated material 30 may have a rectangular, round, oval, octagonal or asymmetrical shape.

In addition, the layer of cloth 32 and the sheet of paper 34 may be any shape, configuration or size as long as the sheet of laminated material 30 formed therefrom can function as described herein. Further, the layer of cloth 32 and the sheet of paper 34 may have different shapes. In this manner, the sheet of laminated material 30 may be provided with various asymmetrical shapes.

The layer of cloth 32 may be substantially the same size as the sheet of paper 34, or the layer of cloth 32 may be substantially larger in width and/or length than the sheet of paper 34. For example, the sheet of paper 34 may only be present on the portion of the sheet of laminated material 30 which will form a base portion of a decorative cover, while the layer of cloth 32 may extend beyond the sheet of paper 34 and form a skirt portion of the decorative cover. Alternatively, the sheet of paper 34 may be substantially larger in width and/or length than the layer of cloth 32.

Further, multiple sheets of laminated material 30 may be used in a single circumstance to provide a decorative cover or sleeve for a floral grouping or a flower pot. Moreover, when multiple sheets of laminated material 30 are used in combination, the sheets of laminated material 30 need not be uniform in size or shape.

Any thickness or stiffness of the layer of cloth 32 and the sheet of paper 34 may be utilized in accordance with the present invention as long as the sheet of laminated material 30 can be wrapped about at least a portion of a floral grouping or a flower pot to form a decorative cover for the floral grouping or flower pot, or formed into a sleeve for wrapping or covering a floral grouping or a flower pot, or to provide a ribbon or decorative grass. Generally, the layer of cloth 32 will have a thickness in a range of from about 0.5 mil to about 30 mil, and desirably from about 0.6 mil to about 10 mil, and the sheet of paper 34 generally will have a thickness in a range of from about 0.5 mil to about 30 mil, and desirably from about 0.6 mil to about 10 mil. While the thickness of the sheet of laminated material 30 can vary widely and will generally depend on the thicknesses of the layer of cloth 32 and the sheet of paper 34, desirable results can be obtained where the sheet of laminated material 30 has a thickness in a range of from about 0.1 mil to about 30 mil, and desirably from about 1.2 mil to about 20 mil.

The sheet of laminated material 30 may vary in color, depending at least in part on the type of cloth utilized as the layer of cloth 32 from which the sheet of laminated material 30 is constructed. The sheet of paper 34 may be tinted, or the sheet of paper 34 may be laminated to the layer of cloth 32 using a tinted bonding material, which can also provide the sheet of laminated material 30 with various colors. Further, the sheet of laminated material 30 may have decorative patterns or designs which are provided on at least one surface thereof which may be provided by printing, embossing, matting, texturing, flocking, application of foamable lacquers or foamable inks, and variations thereof and combinations thereof.

It will be understood that the sheet of laminated material 30 may be provided with a substantially undistorted printed pattern substantially identical to the substantially undistorted printed pattern 24 described herein before with reference to FIG. 1A. The substantially undistorted printed pattern may be applied to the upper surface 36 or the lower surface 38 of the sheet of laminated material 30, and the substantially undistorted printed pattern may be applied to the layer of cloth 32 or the sheet of paper 34, as described herein before for application of the substantially undistorted printed pattern 24 to the sheet of material 10a. In particular, when waxed paper is utilized as the sheet of paper 34, the printed pattern 24 may be applied to a surface of the waxed paper, which will prevent distortion to the printed pattern 24 which may occur if the printed pattern 24 is applied directly to the layer of cloth 32. Alternatively, inks containing pigment and at least one anti-bleeding agent may be applied to the layer of cloth 32 to provide the sheet of laminated material 30 with a substantially undistorted printed pattern.

The term “anti-bleeding agent” as used herein will be understood to include any agent which prevents distortion of the printed pattern 24 and maintains the luster of the printed pattern 24. Such anti-bleeding agents may be compounds commonly incorporated in adhesives, such as sodium silicate, sugar and starch.

Shown in FIG. 3 is a sheet of laminated material 30a constructed in accordance with the present invention. The sheet of laminated material 30a has an upper surface 36a, a lower surface 38a, a first side 40a, a second side 42a, a third side 44a and a fourth side 46a. The sheet of laminated material 30a is constructed of a layer of cloth 32a and a sheet of paper 34a.

A bonding material 48 is disposed on at least a portion of at least one of the upper and lower surfaces 36a and 38a of the sheet of laminated material 30a. The bonding material 48 is depicted in FIG. 3 as being disposed on the lower surface 38a of the sheet of laminated material 30a substantially adjacent the fourth side 46a and extending as a strip between the first and second sides 40a and 42a of the sheet of laminated material 30a. The bonding material 48 may cover a portion of the upper surface 36a and/or lower surface 38a of the sheet of laminated material 30a, or the bonding material 48 may entirely cover the upper surface 36a and/or lower surface 38a of the sheet of laminated material 30a. The bonding material 48 may be disposed on the upper surface 36a and/or lower surface 18a of the sheet of laminated material 30a in the form of a strip (as illustrated in FIG. 3) or in the form of spaced-apart spots. Methods for disposing a bonding material 48 on the sheet of laminated material 30a are described in U.S. Pat. No. 5,111,637, entitled “Method For Wrapping A Floral Grouping”, issued to Weder, et al. on May 12, 1992, which is expressly incorporated herein by reference.

The term “bonding material” when used herein includes adhesives, such as pressure sensitive adhesives, cohesives or any combination thereof. Such bonding materials are known in the art and are commercially available. When the bonding material 48 is a cohesive, a similar cohesive material must be placed on the adjacent surface for bondingly contacting and bondingly engaging with the cohesive material.

The term “bonding material” also includes materials which are heat sealable and, in this instance, the adjacent portions of the material must be brought into contact and then heat must be applied to effect the seal. The term “bonding material” also includes materials which are sonically sealable and vibratory sealable. The term “bonding material” when used herein also includes a heat sealing lacquer or hot melt material which may be applied to the material and, in this instance, heat, sound waves, or vibrations, also must be applied to effect the sealing.

The term “bonding material” when used herein also includes any type of material or element which can be used to effect the bonding or connecting of the two adjacent portions of the sheet of laminated material 30a to effect the connection or bonding described herein. The term “bonding material” may also include ties, labels, bands, ribbons, strings, tapes (including single or double-sided adhesive tapes), staples or combinations thereof. Some of the bonding materials would secure the ends of the material while other bonding materials may bind the circumference of a cover, or a sleeve, or, alternatively and/or in addition, the bonding materials would secure overlapping folds in the material and/or sleeve.

Alternatively, a cold seal adhesive may be utilized as the bonding material 48. The cold seal adhesive adheres only to a similar substrate, acting similarly as a cohesive, and binds only to itself. The cold seal adhesive, since it bonds only to a similar substrate, does not cause a residue to build up on equipment, thereby both permitting much more rapid disposition and use of such equipment to form articles and reducing labor costs. Further, since no heat is required to effect the seal, the dwell time, that is, the time for the sheet of material to form and retain the shape of an article, such as a flower pot cover or flower pot, is reduced. A cold seal adhesive binds quickly and easily with minimal pressure, and such a seal is not readily releasable. This characteristic is different from, for example, a pressure sensitive adhesive.

The term “bonding material” when used herein also includes any heat or chemically shrinkable material, and static electrical or other electrical materials, chemical welding materials, magnetic materials, mechanical or barb-type fastening materials or clamps, curl-type characteristics of the film or materials incorporated in material which can cause the material to take on certain shapes, cling films, slots, grooves, shrinkable materials and bands, curl materials, springs, and any type of welding method which may weld portions of the material to itself or to the pot, or to both the material itself and the pot.

### Description of FIGS. 4-7

FIGS. 4-6 illustrate the use of the sheet of laminated material 30a having the bonding material 48 disposed thereon (FIG. 3) for wrapping a floral grouping 50 having a bloom portion 52 and a stem portion 54 to provide a decorative cover 56 (FIG. 6) for the floral grouping 50. The decorative cover 56, which is provided with a substantially conical configuration, has an open upper end 58 and a lower end 60.

The bonding material 48 disposed on the sheet of laminated material 30a may have a backing or release strip (not shown). The backing or release strip may be left applied for a period of time to the bonding material 48 after it is disposed on the upper or lower surface 36a or 38a of the sheet of laminated material 30a prior to its use as a wrapping material in order to protect the bonding qualities of the strip of bonding material 48.

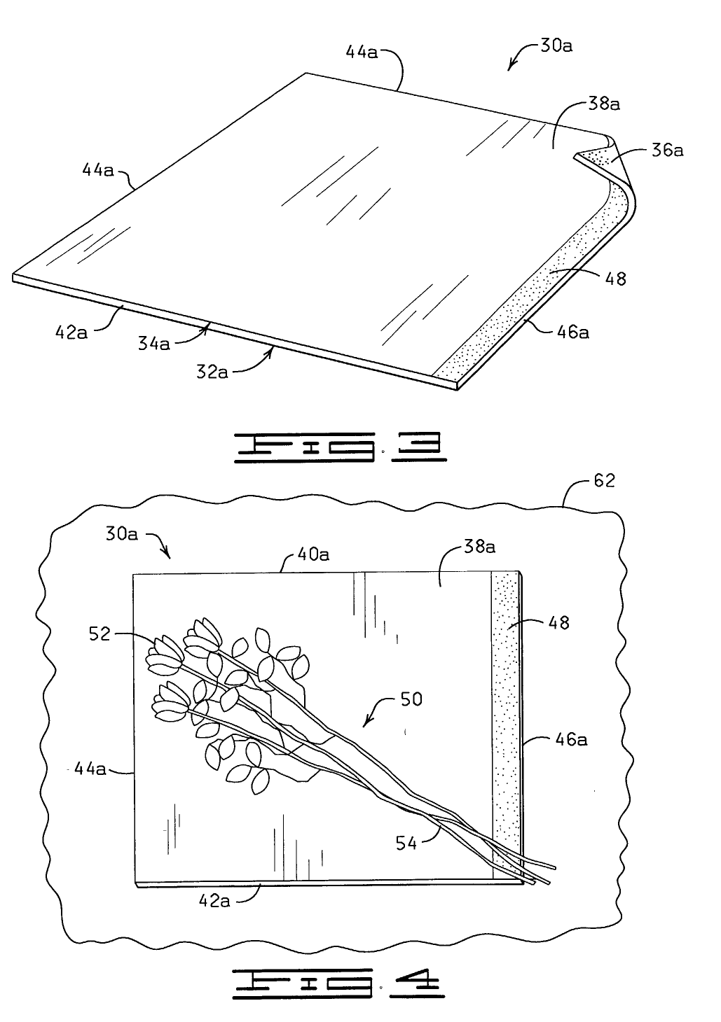

In operation, an operator may dispose the sheet of laminated material 30a on a support surface 62 whereby the upper surface 36a of the sheet of laminated material 30a contacts the support surface 62. The floral grouping 50 is placed upon the lower surface 38a of the sheet of laminated material 30a in a diagonal orientation. The sheet of laminated material 30a is then wrapped about the floral grouping 50 by the operator (FIGS. 5 and 6), the operator overlapping a portion of the sheet of laminated material 30a over another portion of the sheet of laminated material 30a. That is, for example, the operator places the second side 42a of the sheet of laminated material 30a over the floral grouping 50, as shown in FIG. 5. The operator continues to roll the floral grouping 50 and the sheet of laminated material 30a in the direction indicated by the arrow 64 toward the first side 40a of the sheet of laminated material 30a until the lower surface 38a of the sheet of laminated material 30a substantially adjacent the fourth side 46a thereof firmly engages the upper surface 36a of the sheet of laminated material 30a. In this position, the bonding material 48 on the lower surface 38a of the sheet of laminated material 30a contacts the upper surface 36a of the sheet of laminated material 30a to provide the decorative cover 56 which substantially encompasses and surrounds a substantial portion of the floral grouping 50.

FIG. 6 shows the floral grouping 50 wrapped in a conical fashion to provide the decorative cover 56 for the floral grouping 50. When the floral grouping 50 is wrapped in a conical fashion, the bloom portion 52 of the floral grouping 50 is exposed substantially adjacent the open upper end 58 of the decorative cover 56, and the stem portion 54 of the floral grouping 50 is exposed substantially adjacent the lower end 60 of the decorative cover 56.

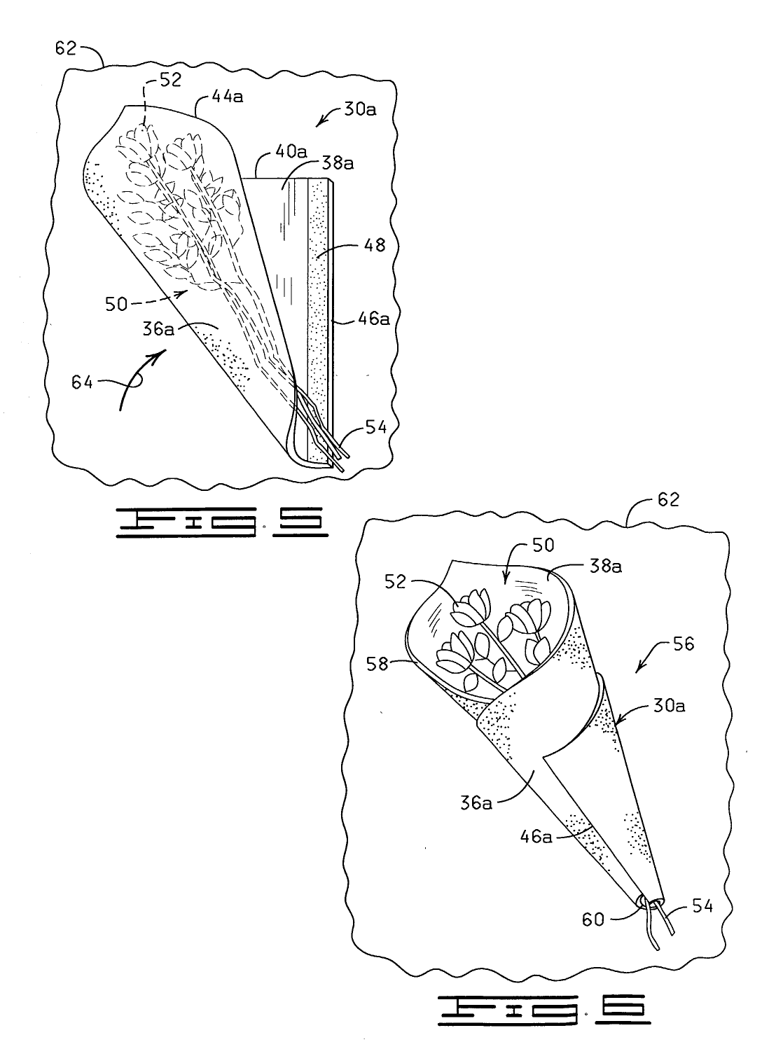

In another embodiment, illustrated in FIG. 7, the sheet of laminated material 30a having the bonding material 48 disposed on the lower surface 38a thereof (FIG. 3) is utilized to wrap the floral grouping 50 in a cylindrical fashion to provide a decorative cover 56a for the floral grouping 50. Referring now to FIG. 3 in combination with FIG. 7, the floral grouping 50 is disposed upon the sheet of laminated material 30a approximately parallel to the third side 44a of the sheet of laminated material 30a. The sheet of laminated material 30a is wrapped generally about the stem portion 54 of the floral grouping 50 to a position wherein the fourth side 46a of the sheet of laminated material 30a generally overlaps the third side 44a of the sheet of laminated material 30a in a cylindrical fashion. As before, the portion of the sheet of laminated material 30a substantially adjacent the fourth side 46a is disposed generally adjacent another portion of the sheet of laminated material 30a, such as the portion of the sheet of laminated material 30a substantially adjacent the third side 44a (as shown in FIG. 7), and the two adjacent portions then are brought into contact where they may be bondingly engaged via the bonding material 48, thereby securing the sheet of laminated material 30a generally about the floral grouping 50 so as to provide the decorative cover 56a for the floral grouping 50. The decorative cover 56a so formed is provided with an open upper end 58a and an open lower end 60a. However, it should be noted that the sheet of laminated material 30a may be wrapped a plurality of times about the stem portion 54 of the floral grouping 50 before the overlapping of the third side 44a and the fourth side 46a of the sheet of laminated material 30a to form the decorative cover 56a and, if desired the open lower end 60a of the decorative cover 56a may be closed such as by crimping and the like.

### Description of FIGS. 8-9

In another version of the invention, the sheet of laminated material 30 described hereinabove with reference to FIG. 2 may be used to wrap a flower pot or pot-type container. However, it is to be understood that the sheets of material 10 and 10a may be utilized in a similar manner, and as such the invention is not limited to the use of the sheet of laminated material 30 as a wrapping for a flower pot or pot-type container.

Shown in FIG. 8 is a flower pot 70 having an open upper end 72, a lower end 74, an outer peripheral surface 76, and an inner retaining space 78 within which may be disposed a growing medium 80 and a botanical item, such as a plant 82 having an upper portion 84 comprising blooms or foliage or both. The sheet of laminated material 30 is wrapped about the outer peripheral surface 76 of the flower pot 70 to provide a decorative cover 86.

Any one of numerous methods known in the art may be used to wrap the sheet of laminated material 30 about the flower pot 70 to form the decorative cover 86. For example, the sheet of laminated material 30 may be formed by hand about the outer peripheral surface 76 of the flower pot 70 to produce the decorative cover 86, which can then be secured about the flower pot 70 by a bonding material or by an elastic band 88 such that the open upper end 72 of the flower pot 70 remains substantially uncovered by the decorative cover 86 substantially as shown in FIG. 8.

Referring now to FIG. 9, a flower pot cover former and band applicator device 90 for forming the sheet of laminated material 30 into the decorative cover 86 for the flower pot 70 of FIG. 8 is illustrated. The flower pot cover former and band applicator device 90 comprises a band applicator 92 and a flower pot cover former 94. The flower pot cover former and band applicator device 90 has a support platform 96 with an opening 98 formed therein. A band, such as the elastic band 88, is disposed circumferentially about the opening 98 in the support platform 96.

The sheet of laminated material 30 is positioned on an upper surface 100 on the support platform 96 so as to be positioned over the opening 98 in the support platform 96. The upper surface 36 of the sheet of laminated material 30 is depicted as being positioned on the upper surface 100 of the support platform 96. However, it should be understood that the lower surface 38 of the sheet of laminated material 30 may be positioned on the upper surface 100 of the support platform 96.

The flower pot 70 is positioned above the sheet of laminated material 30 and is moved in a direction indicated by the arrow 102 into the opening 98 in the support platform 96 of the flower pot cover former and band applicator device 90. As the flower pot 70 is moved into the opening 98, the sheet of laminated material 30 is pressed about the outer peripheral surface 76 of the flower pot 70 thereby forming the decorative cover 86 about the flower pot 70. The decorative cover 86 is then secured about the flower pot 70 by the elastic band 88. The flower pot 70 having the decorative cover 86 secured thereto is then moved in a direction indicated by the arrow 104 out of the opening 98 in the support platform 96 of the flower pot cover former and band applicator device 90.

The elastic band 88 can be applied manually or automatically such as by the method shown in U.S. Pat. No. 5,105,599, issued to Weder et al. on Apr. 21, 1992, which is hereby expressly incorporated herein by reference. The elastic band 88 can also be applied as a tie using a method such as described in “Single Station Covering and Fastening System”, U.S. Pat. No. 5,609,009, issued to Weder et al. on Mar. 11, 1997, the specification of which is hereby expressly incorporated herein by reference. The sheet of laminated material 30 can also be applied automatically about the flower pot 70, for example, by methods shown in U.S. Pat. Nos. 4,733,521 and 5,291,721, both of which are hereby expressly incorporated herein by reference.

Instead of securing the decorative cover 86 about the flower pot 70 via the elastic band 88, the decorative cover 86 formed from the sheet of laminated material 30 may be secured to the flower pot 70 by the use of one or more bonding materials. For example, the lower surface 38 of the sheet of laminated material 30 may have a bonding material such as the bonding material 48 disposed upon a portion thereof. When the sheet of laminated material 30 is disposed about the flower pot 70, at least a portion of the lower surface 38 of the sheet of laminated material 30 contacts the outer peripheral surface 76 of the flower pot 70 and is thereby bonded and held about the flower pot 70 via the bonding material 48.

### Description of FIGS. 10-13

Shown in FIGS. 10 and 11 and designated therein by the general reference numeral 110 is a flexible bag or sleeve constructed in accordance with the present invention. The sleeve 110 may be used as a decorative cover 112 for a floral grouping or a flower pot (FIG. 11). The sleeve 110 initially is in a flexible flattened state or condition which is openable to an open state or condition capable of receiving a floral grouping or a potted plant.

The sleeve 110 has an open upper end 114, a lower end 116 and an outer peripheral surface 118. The lower end 116 of the sleeve 110 may be open or closed with a bottom at the lower end 116. The sleeve 110 also has an inner peripheral surface 120 which defines and encompasses an inner retaining space 122. When the lower end 116 of the sleeve 110 is closed, a portion of the lower end 116 may be inwardly folded to form one or more gussets (not shown) for allowing the lower portion of the inner retaining space 122 to be expandable, for example, for receiving a circular bottom of a flower pot.

The sleeve 110 may be tapered outwardly from the lower end 116 toward a larger diameter at its upper end 114. In its flattened state the sleeve 110 generally has an overall cylindrical or frusto-conical shape, and when opened is substantially frusto-conical in configuration. It will be appreciated, however, that the sleeve 110 may have variations on the aforementioned shapes or may have significantly altered shapes such as square or rectangular or any geometric, non-geometric, asymmetrical and/or fanciful shape or configuration, as long as the sleeve 110 functions in accordance with the present invention in the manner described herein. The sleeve 110 may also be equipped with drain holes (if having a closed bottom) or side ventilation holes (not shown), or can be made from gas permeable or impermeable materials.

The sleeve 110 may be constructed from a material similar to the sheet of material 10, the sheet of material 10a, or the sheet of laminated material 30 (described hereinbefore with reference to FIGS. 1, 1A and 2, respectively). Any thickness of the material from which the sleeve 110 is constructed may be utilized in accordance with the present invention as long as the sleeve 110 may be formed as described herein and as long as the sleeve 110 may contain at least a portion of a flower pot or a floral grouping, as described herein. Additionally, an insulating material such as bubble film can be utilized in order to provide additional protection for the item, such as a floral grouping, contained therein.

In FIG. 11 the sleeve 110 is illustrated as having the floral grouping 50 described hereinbefore with reference to FIGS. 4-7 disposed within the inner retaining space 122 of the sleeve 110. Generally, the bloom portion 52 of the floral grouping 50 is disposed substantially adjacent the open upper end 114 of the sleeve 110 and the stem portion 54 of the floral grouping 50 is disposed substantially adjacent the lower end 116 of the sleeve 110. Either end of the sleeve 110 may be closed about the floral grouping 50. Generally, a portion of the sleeve 110 is tightened about a portion of the stem portion 54 of the floral grouping 50 for holding the decorative cover 112 about the floral grouping 50. For example, the sleeve 110 may be held by a banding element 124 tied about the sleeve 110 such as is shown in FIG. 11. The step of tying the banding element 124 about a portion of the sleeve 110 results in a crimping of such portion of the sleeve 110 such that the crimped portion of the sleeve 110 substantially conforms to the stem portion 54 of the floral grouping 50. While the banding element 124 has been illustrated herein as a string or ribbon, it is to be understood that the banding element 124 can be elastic or non-elastic bands, elastic or non-elastic string, an elastic or non-elastic piece of material, a round piece of material, a flat piece of material, a ribbon, a piece of paper strip, a piece of plastic strip, a piece of wire, a tie wrap, a twist tie or combinations thereof.

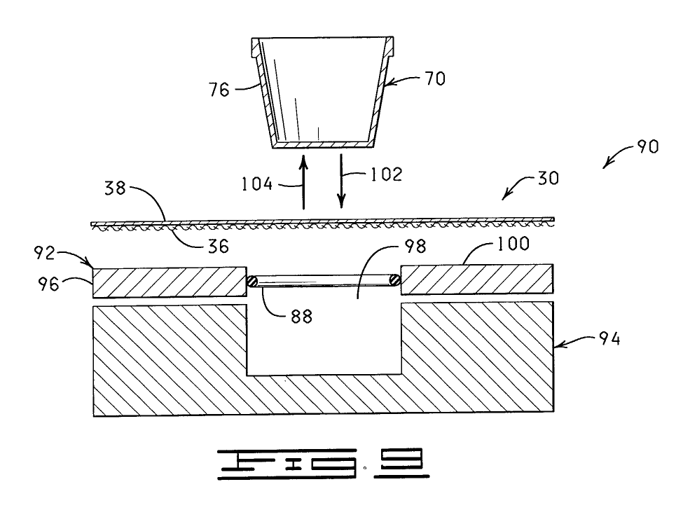

Other methods for binding the sleeve 110 about the floral grouping 50 may be employed such as the bonding materials described elsewhere herein. For example, shown in FIGS. 12 and 13 is a sleeve 110a which is substantially similar to the sleeve 110 described hereinbefore with reference to FIGS. 10 and 11, except that the sleeve 110a also comprises a cinching tab 126 having a bonding material 128 disposed upon a surface thereof. Upon disposal of the floral grouping 50 in an inner retaining space 122a of the sleeve 110a, the cinching tab 126 can be used to gather portions of the sleeve 110a together about the stem portion 54 of the floral grouping 50 as shown in FIG. 13 and bondingly connected to the sleeve 110a for holding the sleeve 110a about the floral grouping 50, thereby forming a decorative cover 112a which is bound about the floral grouping 50.

### Description of FIGS. 14-16

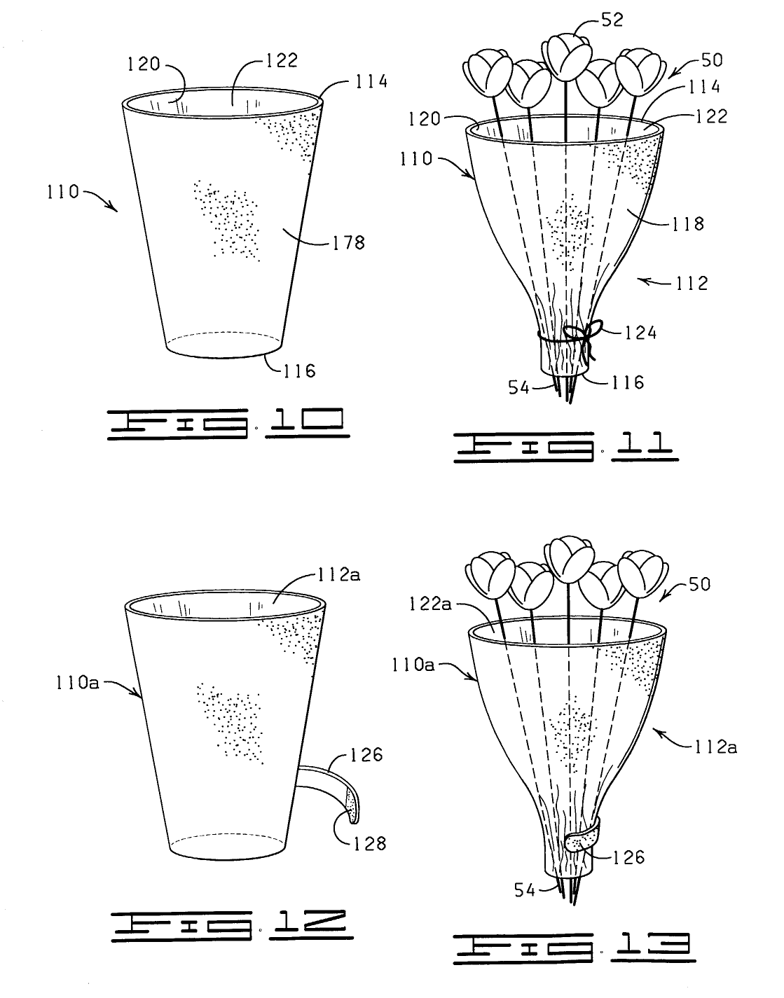

Shown in FIGS. 14 and 15 is another embodiment of a sleeve designated by the reference numeral 130 and constructed in accordance with the present invention. The sleeve 130 may be constructed from a material similar to the sheet of material 10, the sheet of material 10a, or the sheet of laminated material 30 (described hereinbefore with reference to FIGS. 1, 1A and 2, respectively). The sleeve 130 has one or more “detaching” elements in predetermined areas for detaching a portion of the sleeve 130, as will be described in more detail herein after. The sleeve 130 generally is initially in a flexible flattened state or condition which is openable to an open state or condition capable of receiving a flower pot or growing medium therein.

The sleeve 130 has an upper end 132, a lower end 134, and an outer peripheral surface 136. The sleeve 130 may be open at the lower end 134 or closed with a bottom at the lower end 134. In a flattened state, the sleeve 130 has a first side 138 and a second side 140. The sleeve 130 also has an inner peripheral surface 142 which, when the sleeve 130 is opened, defines and encompasses an inner retaining space 144 as shown in FIG. 15. When the lower end 134 of the sleeve 130 is closed, a portion of the lower end 134 may be inwardly folded to form one or more gussets (not shown) for permitting a circular bottom of an object such as the flower pot 70, described hereinbefore with reference to FIG. 8, to be disposed in the inner retaining space 144 of the lower end 134 of the sleeve 130.

As shown in FIGS. 14 and 15, the sleeve 130 is demarcated into an upper portion 146 and a lower portion 148. The lower portion 148 of the sleeve 130 is generally sized to contain the flower pot 70. The upper portion 146 of the sleeve 130 is sized to substantially surround and encompass the plant 82 contained in the flower pot 70 disposed within the lower portion 148 of the sleeve 130. The sleeve 130 is demarcated into the upper portion 146 and the lower portion 148 by a detaching element 150 for enabling the detachment of the upper portion 146 of the sleeve 130 from the lower portion 148 of the sleeve 130. In the present version, the detaching element 150 is a plurality of alternating diagonally-oriented perforations which extend circumferentially across the outer peripheral surface 136 of the sleeve 130 from the first side 138 to the second side 140.

The lower portion 148 of the sleeve 130 further comprises a base portion 152 and a skirt portion 154. The base portion 152 of the lower portion 148 of the sleeve 130 comprises that part of the lower portion 148 of the sleeve 130 which, when the flower pot 70 is placed into the lower portion 148 of the sleeve 130, a portion of the inner peripheral surface 142 thereof is substantially adjacent to and surrounds the outer peripheral surface 76 of the flower pot 70. The skirt portion 154 of the lower portion 148 of the sleeve 130 comprises that part of the lower portion 148 of the sleeve 130 which extends beyond the open upper end 72 of the flower pot 70 and surrounds at least a portion of the plant 82 contained within the flower pot 70 and which is left to freely extend at an angle, inwardly or outwardly, from the base portion 152 when the upper portion 146 of the sleeve 130 is detached from the lower portion 148 of the sleeve 130.

In the intact sleeve 130, the skirt portion 154 of the lower portion 148 of the sleeve 130 is provided with an upper peripheral edge 156 congruent with the detaching element 150; and the upper portion 146 of the sleeve 130 is provided with a lower peripheral edge 158 which is also congruent with the detaching element 150. In FIGS. 14 and 15, the upper peripheral edge 156 of the skirt portion 154 of the lower portion 148 of the sleeve 130 is congruent with a series of alternating diagonally-oriented lines of perforations which together form a zig-zag and comprise the detaching element 150.

The upper portion 146 of the sleeve 130 may also have an additional detaching element 160 indicated as a plurality of vertical perforations for facilitating removal of the upper portion 146 of the sleeve 130 and which extends between the detaching element 150 of the sleeve 130 and the upper end 132 of the sleeve 130.

The upper portion 146 of the sleeve 130 is thereby separable from the lower portion 148 of the sleeve 130 by tearing the upper portion 146 along both the detaching element 150 and the detaching element 160, thereby separating the upper portion 146 from the lower portion 148 of the sleeve 130. The lower portion 148 of the sleeve 130 remains disposed as the base portion 152 about the flower pot 70 and as the skirt portion 154 about a lower portion of the plant 82 disposed in the flower pot 70, thereby forming a decorative cover 162 as shown in FIG. 16 which substantially surrounds and encompasses the flower pot 70 and a portion of the plant 82 contained therein.

While the detaching elements 150 and 160 have been shown and described herein as being a plurality of perforations, it is to be understood that the term “detaching element” as used herein, means any element, or combination of elements, or features, including perforations, tear strips, zippers, and any other devices or elements or combinations thereof capable of functioning to assist in the removal of the upper portion 146 of the sleeve 130 from the lower portion 148 of the sleeve.

The upper and lower portions 146 and 148 of the sleeve 130 may be formed of a laminated material similar to the sheet of material 30 described hereinbefore and consisting of a layer of cloth similar to the layer of cloth 32 and a sheet of paper similar to the sheet of paper 34. Alternatively, only the lower portion 148 of the sleeve 130 may be formed of a two-layered material and the upper portion 146 of the sleeve 130 formed of a single layer of material, that is, the lower portion 148 may consist of a layer of cloth and a sheet of paper, and the layer of cloth extends therefrom and forms the upper portion 146 of the sleeve 130 while the sheet of paper is only present in the lower portion 148 of the sleeve 130. Alternatively, only the base portion 152 of the lower portion 148 of the sleeve 130 may be formed of a two-layered material, and the skirt portion 154 of the lower portion 148 as well as the upper portion 146 of the sleeve 130 are formed of a single layer, that is, either the sheet of paper or the layer of cloth may only be present in the base portion 152 of the lower portion 148 of the sleeve 130, while the other layer is present in both the upper and lower portions 126 and 128 of the sleeve 130.

In a general method of use of sleeve 130 as the decorative cover 162 for the flower pot 70, an operator provides the sleeve 130 and the flower pot 70 having a plant 82 disposed in a growing medium 80 contained within the inner retaining space 78 of the flower pot 70. The operator then manually or automatically disposes the flower pot 70 into the inner retaining space 144 of the sleeve 130, the flower pot 70 being disposed generally through the upper portion 146 of the sleeve 130 into generally the lower portion 148 of the sleeve 130, the flower pot 70 remaining in the lower portion 148 of the sleeve 130, permitting the sleeve 130 to substantially surround and encompass the flower pot 70 and the plant 82 disposed in the flower pot 70 (FIG. 15). It will be understood that alternatively, the sleeve 130 may be provided with an extension (not shown), and the sleeve 130 may be disposed on rods or wickets, and the flower pot 70 may then be disposed in the sleeve 130 either before or after the sleeve 130 has been removed from the wickets.

As noted above, a bonding material may be disposed on a portion of the sleeve 130 or any sleeve described herein to assist in holding the sleeve 130 to the flower pot 70 when the flower pot 70 is disposed within the sleeve 130 or to assist in closing the upper end 132 of the sleeve 130.

It will be understood that the bonding material, if present, may be disposed as a strip or block on a surface of the sleeve 130. The bonding material may also be disposed upon either the outer peripheral surface 136 or the inner peripheral surface 142 of the sleeve 130, as well as upon the outer peripheral surface 76 of the flower pot 70. Further, the bonding material may be disposed as spots of bonding material, or in any other geometric, non-geometric, asymmetric, or fanciful form, and in any pattern, including covering either the entire inner peripheral surface 142 and/or outer peripheral surface 136 of the sleeve 130 and/or the flower pot 70. The bonding material may be covered by a cover or release strip which can be removed prior to the use of the sleeve 130 or flower pot. The bonding material can be applied by methods known to those of ordinary skill in their art. One method for disposing a bonding material, in this case an adhesive, is described in U.S. Pat. No. 5,111,637, issued to Weder et al. on May 12, 1993, which is hereby expressly incorporated herein by reference.

As noted above, a bonding material may be disposed on at least a portion of the inner peripheral surface 142 of the sleeve 130, or, alternatively, the bonding material may be disposed on the outer peripheral surface 76 of the flower pot 70 contained within the sleeve 130, while the sleeve 130 may be free of the bonding material. In a further alternative, the bonding material may be disposed both on at least a portion of the flower pot 70 as well as upon at least a portion of the inner peripheral surface 142 of the sleeve 130. In addition, a portion of the bonding material may also be disposed on the outer peripheral surface 136 of the sleeve 130 as well. It will be understood that the bonding material may be disposed in a solid section of bonding material. The bonding material, when present, is disposed on the sleeve 130 and/or flower pot 70 by any method known in the art.

### Description of FIGS. 17-20

Referring now to FIG. 17, designated generally by the reference numeral 170 is a ribbon material formed of cloth and constructed in accordance with the present invention. The ribbon material 170 can be wrapped about items and formed into bows and other decorative ornamentations containing ruffles, loops and curved segments. The ribbon material 170 is provided with an upper surface 172 and a lower surface 174. The ribbon material 170 is formed from the sheet of material 10 described hereinbefore with reference to FIG. 1.

The ribbon material 170 may be formed from a sheet of material 10 in various ways which are known in the art. For example, the sheet of material 10 may be provided as a roll of material, and material withdrawn from the roll may be passed through a knife assembly having a plurality of cutting elements which cuts the material into strips having a uniform, predetermined width to form the ribbon material 170. The ribbon material 170 may also be formed in a similar manner from the roll of cloth 26 (described herein before with reference to FIG. 1B).

The ribbon material 170 so produced can then be wound via take up rollers to produce spools of the ribbon material 170 in a conventional manner. It should also be understood that the sheet of material 10 from which the ribbon material 170 is constructed may be provided with a width which corresponds to the desired width of the ribbon material 170. In such event, the cutting of the sheet of material 10 to produce the ribbon material 170 can be eliminated. The production of ribbon material from webs or sheets of material is well known. Thus, no further description of the production of the ribbon material 170 from the sheet of material 10 is believed necessary.

Shown in FIG. 18 is a ribbon material 170a having an upper surface 172a and a lower surface 174a and constructed similar to the ribbon material 170 described in detail herein before, except as described herein below. The ribbon material 170a is provided with a substantially undistorted printed pattern 176 and may be formed from the sheet of material 10a (described herein before with reference to FIG. 1A) or from the roll of cloth 26 (described herein before with reference to FIG. 1B) following application of the substantially undistorted printed pattern 24 thereto, such that at least a portion of the ribbon material 170a is provided with the substantially undistorted printed pattern 176 thereon. The printed pattern 176 may be disposed on at least a portion of the upper surface 172a and/or the lower surface 174a of the ribbon material 170a. The printed pattern 176 may lie within the boundaries of the ribbon material 170a, or the printed pattern 176 may be disposed randomly on the ribbon material 170a.

Shown in FIG. 19 is a ribbon material 180 formed of a laminated material and constructed in accordance with the present invention. The ribbon material 180 can be wrapped about items and formed into bows and other decorative ornamentations containing ruffles, loops and curved segments. The ribbon material 180 is provided with an upper surface 182 and a lower surface 184. The ribbon material 180 is formed from the sheet of material 30 described hereinbefore with reference to FIG. 2 and comprises a layer of cloth 186 at least partially laminated to a sheet of paper 188.

The ribbon material 180 may be formed from a sheet of material 30 in various ways which are known in the art. For example, the sheet of material 30 may be provided as a roll of material, and material withdrawn from the roll may be passed through a knife assembly having a plurality of cutting elements which cuts the material into strips having a uniform, predetermined width to form the ribbon material 180.

The ribbon material 180 so produced can then be wound via take up rollers to produce spools of the ribbon material 180 in a conventional manner. It should also be understood that the sheet of material 30 from which the ribbon material 180 is constructed may be provided with a width which corresponds to the desired width of the ribbon material 180. In such event, the cutting of the sheet of material 30 to produce the ribbon material 180 can be eliminated. The production of ribbon material from webs or sheets of material is well known. Thus, no further description of the production of the ribbon material 180 from the sheet of material 30 is believed necessary.

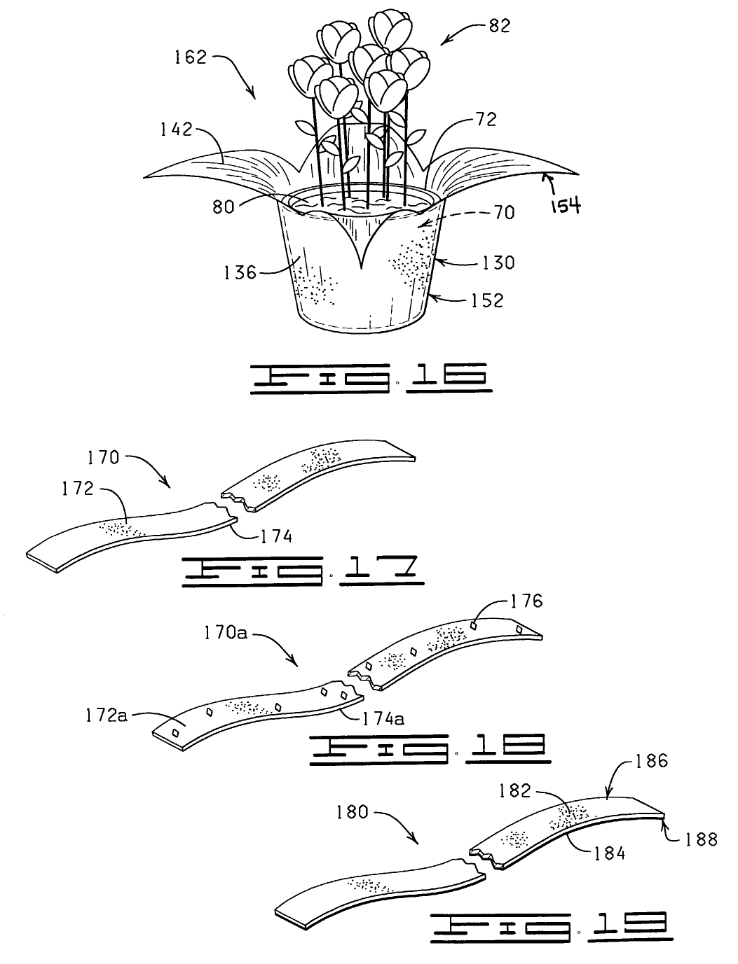

Shown in FIG. 20 is a ribbon material 180a which is similar to the ribbon material 180 as described herein before. The ribbon material 180a is formed of a laminated material comprising a layer of cloth 186a and a sheet of paper 188a. The ribbon material 180a has an upper surface 182a and a lower surface 184a. At least a portion of at least one of the upper surface 182a and/or the lower surface 184a is provided with a substantially undistorted printed pattern 189 disposed thereon. The printed pattern 189 may lie within the boundaries of the ribbon material 180a or may be positioned randomly on the ribbon material 180a.

### Description of FIGS. 21-24

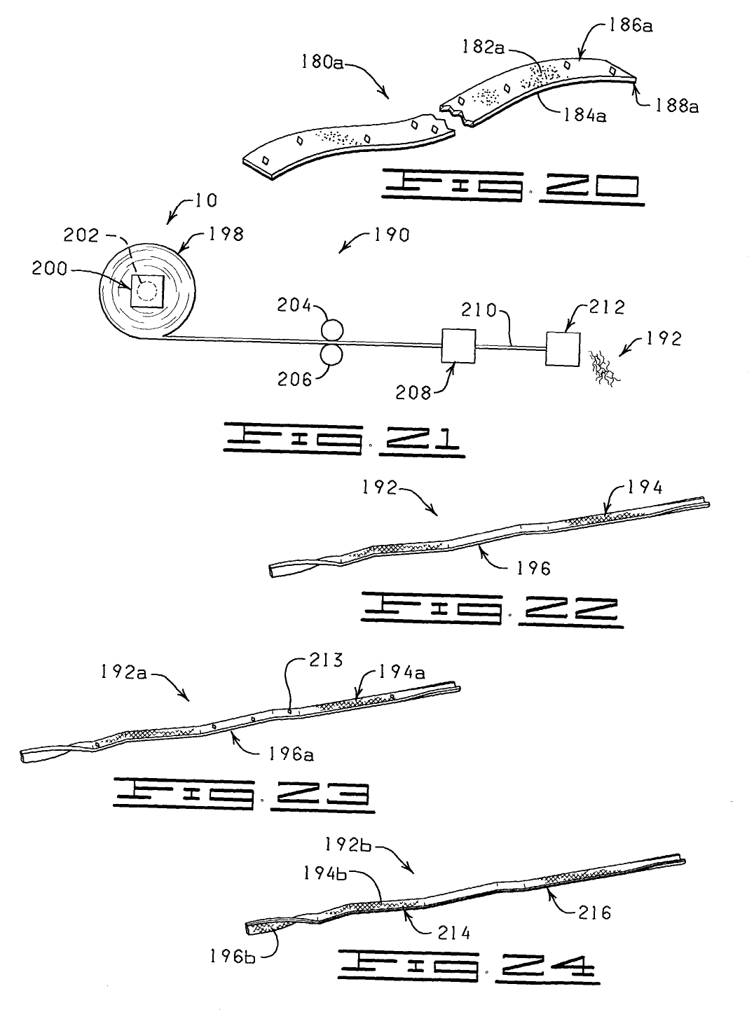

Referring now to FIG. 21, designated generally by the reference numeral 190 is a system for producing decorative grass 192 formed of cloth and constructed in accordance with the present invention. As shown in FIG. 22, the decorative grass 192 is provided with an upper surface 194 and a lower surface 196. The decorative grass 192 is formed from the sheet of material 10 described hereinbefore with reference to FIG. 1.

Referring again to FIG. 21, a roll 198 of material comprising the sheets of material 10 is supported on a mandrel 200 having a brake assembly 202 operably connected thereto so that the material can be controllably withdrawn from the roll 198. The material withdrawn from the roll 198 is passed through a pair of tension or nip rollers 204 and 206 and into a slitter or shredder unit 208 where the material from the roll 198 is slit to provide a slit web of material 210 having a plurality of strips of predetermined width. The slitting of the material from the roll 198 to produce the slit web of material 210 having a plurality of strips of predetermined width can be accomplished using any well known method and device. Such common methods of slitting the material from the roll 198 include: (a) slitting the material to produce side-by-side strips of material wherein the longer dimension of the strips is in the direction of travel of the material, i.e. the machine direction; or (b) slitting the material so that the longer dimension of the strips of material are oblique to the direction of travel of the material, i.e. obliquely to the machine direction.

The slit web of material 210 having a plurality of strips of predetermined width is then passed through a cutting unit 212 where the strips of the slit web of material 210 are cut into segments to form the decorative grass 192.

Any conventional device and method can be employed as the slitter or shredder unit 208 and as the cutting unit 212. Examples of conventional devices which can be used as the slitter or shredder unit 208 and/or as the cutting unit 212 are rotary knives, reciprocating knives, die cutting, laser cutting, water jet cutting, air jet cutting and the like.

The decorative grass 192 can then be conveyed to a storage area (not shown) which may be in the form of a suitable bin, or the decorative grass 192 may be conveyed to a packaging machine, or conveyed to a baling machine for baling prior to storage. As other alternatives, the decorative grass 192 may be placed into boxes or cartons, subjected to further processing immediately or held for subsequent processing.

The decorative grass 192 can also be provided with various types of curl configurations, can be crimped or otherwise modified. That is, various types of curls, crimps and combinations thereof can be imparted to the material of the roll 198 prior to slitting the material of the roll 198 to produce the slit web of material 210, or to the slit web of material 210 prior to cutting the slit web of material 210 to produce the decorative grass 192. Any method or apparatus capable of imparting the desired curl and/or crimp to the material of the roll 198 so that the decorative grass 192 produced from such material possess a curl and/or crimped configuration can be employed to impart a curl and/or crimp to the webs of material. Examples of various methods and apparatus which may be used to impart curl configurations to the material of the roll 198 so that the decorative grass 192 produced therefrom possesses a curl configuration are described in co-pending application U.S. Ser. No 09/591,920, entitled “Method And Apparatus For Making Curled Decorative Grass” which is hereby expressly incorporated herein by reference. Crimping machines capable of imparting the desired crimp to the material of the roll 198 so that the decorative grass 192 produced therefrom possesses a crimped configuration are well known and commercially available. One method for imparting a crimp configuration to the material of the roll 198 so that the decorative grass 192 produced therefrom possesses a crimped configuration is disclosed in U.S. Pat. No. 5,891,286, entitled “Method Of Forming Curled Or Crimped Decorative Elements Having An Optical Effect” issued to Weder on Apr. 6, 1999, which is hereby expressly incorporated herein by reference.

Shown in FIG. 23 is a decorative grass 192a having an upper surface 194a and a lower surface 196a. The decorative grass 192 is similar to the decorative grass 192 described hereinbefore with reference to FIG. 22, and produced using the system 190, except that the roll of material 198 comprises either the layer of cloth 26 (described herein before with reference to FIG. 1B) after application of the substantially undistorted printed pattern 24 thereto, or the sheet of material 10a having the substantially undistorted printed pattern 24 applied thereto. The decorative grass 192a formed in this manner is provided with a substantially undistorted printed pattern 213 disposed on at least a portion of the segments of decorative grass 192a. The printed pattern 213 may be within the boundaries of each segment of decorative grass 192a, or the printed pattern 213 may be disposed randomly on the segments of decorative grass 192a.

Shown in FIG. 24 is a decorative grass 192b having an upper surface 194b and a lower surface 196b. The decorative grass 192b is similar to the decorative grass 192 described hereinbefore with reference to FIG. 22, and produced using the system 190, except that the roll of material 198 is formed of the sheets of laminated material 30. Therefore, the decorative grass 192b comprises a layer of cloth 214 and a sheet of paper 216. It will be understood that the decorative grass 192b may also be provided with a substantially undistorted printed pattern disposed thereon.

While certain embodiments have been described herein as being formed from one of the sheet of material 10, the sheet of material 10a or the sheet of laminated material 30, it will be understood that all of the embodiments described herein can be formed from any of the sheet of material 10, the sheet of material 10a or the sheet of laminated material 30, and that the use of one of the sheets of material 10, 10a or 30 in a certain embodiment is not to be construed as limiting.

Changes may be made in the construction and the operation of the various components, elements and assemblies described herein or in the steps or the sequence of steps of the methods described herein without departing from the spirit and scope of the invention as defined in the following claims.

What is claimed:

1. A decorative grass produced by slitting and cutting a sheet of material into segments, the sheet of material being formed of cloth wherein the cloth is selected from the group consisting of woven fabric, nonwoven fabric, welded fabric, spun-bonded fabric, knitted fabric, pressed fabric and combinations and blends thereof.

2. The decorative grass of claim 1 wherein the sheet of material has a thickness in a range of from about 0.5 mil to about 30 mil.

3. The decorative grass of claim 1 wherein the sheet of material is provided with a decorative pattern or design disposed thereon.

4. The decorative grass of claim 3 wherein the decorative pattern or design is provided by at least one of embossing, matting, texturing, flocking, application of foamable lacquers or foamable inks, and variations thereof and combinations thereof.

5. A decorative grass produced by slitting and cutting a sheet of laminated material into segments, the sheet of laminated material comprising:
a layer of cloth selected from the group consisting of woven fabric, nonwoven fabric, welded fabric, spun-bonded fabric, knitted fabric, pressed fabric and combinations and blends thereof; and
a sheet of paper laminated to at least a portion of the layer of cloth.

6. The decorative grass of claim 5 wherein the layer of cloth has a thickness in a range of from about 0.5 mil to about 30 mil and wherein the sheet of paper laminated to the layer of cloth has a thickness in a range of from about 0.5 mil to about 30 mil.

7. The decorative grass of claim 5 wherein at least one surface of the sheet of laminated material is provided with a decorative pattern or design disposed thereon.

8. The decorative grass of claim 7 wherein the decorative pattern or design is provided by at least one of embossing, matting, texturing, flocking, application of foamable lacquers or foamable inks, and variations thereof and combinations thereof.

9. A decorative grass produced by slitting and cutting a sheet of material into segments, the sheet of material being formed of cloth wherein the cloth is selected from the group consisting of woven fabric, nonwoven fabric, welded fabric, spun-bonded fabric, knitted fabric, pressed fabric and combinations and blends thereof, the sheet of material having a substantially undistorted printed pattern thereon such that at least a portion of the segments of decorative grass produced from the sheet of material are provided with a substantially undistorted printed pattern thereon.

10. The decorative grass of claim 9, wherein the pattern is printed on the sheet of material by application of an ink containing pigment and at least one of sodium silicate, sugar or starch.

11. A decorative grass produced by cutting a sheet of laminated material into segments, the sheet of laminated material comprising:
a layer of cloth selected from the group consisting of woven fabric, nonwoven fabric, welded fabric, spun-bonded fabric, knitted fabric, pressed fabric and combinations and blends thereof;
a sheet of paper laminated to at least a portion of the layer of cloth; and
wherein at least one of the layer of cloth, the sheet of paper and the sheet of laminated material is provided with a substantially undistorted pattern printed thereon such that at least a portion of the segments of decorative grass formed from the sheet of laminated material are provided with a substantially undistorted printed pattern thereon.

12. The decorative grass of claim 11 wherein the sheet of paper laminated to the layer of cloth is wax paper, and wherein the pattern is printed on the sheet of waxed paper.

13. The decorative grass of claim 11, wherein the pattern is printed on at least one of the layer of cloth, the sheet of paper and the sheet of laminated material by application of an ink containing pigment and at least one of sodium silicate, sugar or starch.

14. A method for making decorative grass comprising the steps of:
providing a sheet of material, the sheet of material being formed of cloth wherein the cloth is selected from the group consisting of woven fabric, nonwoven fabric, welded fabric, spun-bonded fabric, knitted fabric, pressed fabric and combinations and blends thereof;
cutting at least a portion of the sheet of material formed of cloth to form decorative grass.

15. The method for making decorative grass of claim 14 wherein the step of cutting at least a portion of the sheet of material is further defined as slitting the sheet of material to provide a slit web of material having a plurality of strips and thereafter cutting the plurality of strips of the slit web of material into segments to form the decorative grass.

16. The method for making decorative grass of claim 14 wherein, in the step of providing the sheet of material formed of cloth, the sheet of material is provided with a thickness in a range from about 0.5 mil to about 30 mil.

17. The method for making decorative grass of claim 14 wherein, in the step of providing the sheet of material formed of cloth, at least one surface of the sheet of material is provided with a decorative pattern or design disposed thereon.

18. The method for making decorative grass of claim 17 wherein the decorative pattern or design on at least one surface of the sheet of material formed of cloth is provided by at least one of embossing, matting, texturing, flocking, application of foamable lacquers or foamable inks, and variations thereof and combinations thereof.

19. A method for forming decorative grass comprising the steps of:
providing a laminated material comprising a layer of cloth and a sheet of paper at least partially laminated to the layer of cloth, the layer of cloth selected from the group consisting of woven fabric, nonwoven fabric, welded fabric, spun-bonded fabric, knitted fabric, pressed fabric and combinations and blends thereof; and
cutting at least a portion of the laminated material to produce decorative grass.

20. The method for forming decorative grass of claim 19 wherein the step of cutting at least a portion of the laminated material to form decorative grass comprises:
slitting the laminated material to provide a slit laminated material having a plurality of strips; and
cutting the plurality of strips of the slit laminated material into segments to form decorative grass.

21. The method for forming decorative grass of claim 19 wherein, in the step of providing a laminated material, the layer of cloth has a thickness in a range of from about 0.5 mil to about 30 mil, and the sheet of paper has a thickness in a range of from about 0.5 mil to about 10 mil.

22. The method for forming decorative grass of claim 19 wherein, in the step of providing a laminated material, at least one surface of the sheet of laminated material is provided with a decorative pattern or design disposed thereon.

23. The method for forming decorative grass of claim 22 wherein the decorative pattern or design on at least one surface of the laminated material is provided by at least one of embossing, matting, texturing, flocking, application of foamable lacquers or foamable inks, and variations thereof and combinations thereof.
